(19) United States
(12) Patent Application Publication
(10) Pub. No.: US 2026/0106776 A1
(43) Pub. Date: Apr. 16, 2026

(54) METHOD AND APPARATUS FOR COMMUNICATIVELY CONNECTING A NEW ELECTRONIC CONTROL UNIT IN A VEHICLE

(71) Applicants: HYUNDAI MOTOR COMPANY, Seoul (KR); KIA CORPORATION, Seoul (KR)

(72) Inventor: Seung Su Kim, Hwaseong-si (KR)

(73) Assignees: HYUNDAI MOTOR COMPANY, Seoul (KR); KIA CORPORATION, Seoul (KR)

(21) Appl. No.: 19/229,917

(22) Filed: Jun. 5, 2025

(30) Foreign Application Priority Data
Oct. 11, 2024 (KR) 10-2024-0138291

(51) Int. Cl. H04L 12/413; H04L 12/40; H04W 4/48; H04W 60/04; H04W 74/0816; H04W 88/16

(52) U.S. Cl. CPC H04L 12/413; H04W 4/48; H04W 60/04; H04W 74/0816; H04L 2012/40273; H04W 88/16

(57) ABSTRACT

A method performed by a gateway node in a vehicle includes detecting a first electronic control unit in the vehicle and determining whether to perform pairing with the first electronic control unit using first information received from the first electronic control unit. The method also includes performing pairing with the first electronic control unit based on determining that the electronic control unit and the message requested by the first electronic control unit are present in a communication channel. The method further includes transmitting Physical Layer Collision Avoidance (PLCA) registration request information to a master node based on the pairing and transmitting a beacon received from the master node to the first electronic control unit based on determining that information about a node identifier (ID) of the first electronic control unit and information about Transmission Opportunity (TO) of the first electronic control unit are set by the master node.

### CROSS-REFERENCE TO RELATED APPLICATIONL FIELD

This application claims the benefit of and priority to Korea Patent Application No. 10-2024-0138291, filed on Oct. 11, 2024, the entire contents of which are hereby incorporated herein by reference.

### TECHNICAL FIELD

The present disclosure relates to a method and apparatus for communicatively connecting a new electronic control unit in a vehicle.

### BACKGROUND

The statements in this Background section merely provide background information related to the present disclosure and may not constitute prior art.

An in-vehicle network (IVN) is a wired or wireless communication network between a sensor and an electronic control unit in a vehicle. Among IVNs, a 10BASE-T1S Ethernet network is a network that transmits data at a speed of 10 Mbps in an environment such as a vehicle where noise and electromagnetic waves exist. Unlike a conventional Ethernet network, the 10BASE-T1S Ethernet network facilitates data transmission over a single channel. The 10BASE-T1S Ethernet network performs a Physical Layer Collision Avoidance (PLCA)-based operation to support a multi-drop network. The multi-drop network is a network that connects multiple terminals to a single communication line. The PLCA assigns priority to each electronic control unit in the vehicle by assigning an ID to each electronic control unit and allocating a certain amount of work time to each electronic control unit. The PLCA transmits a collision signal to an upper layer when the electronic control unit transmits data and the communication line is being used by another electronic control unit, thereby stopping transmitting data. Thus, no collisions occur on the communication line. When a new electronic control unit is added to the IVN, it is difficult to change the IVN, so there is a problem in communicatively connecting the new electronic control unit to the 10BASE-T1S Ethernet network.

### SUMMARY

In view of the above, the present disclosure is to detect a new electronic control unit in a vehicle and pair the new electronic control unit with a gateway node.

Further, according to one embodiment, the present disclosure is to set a node identifier (ID) and Transmission Opportunity (TO) information about a new electronic control unit in a vehicle.

Further, according to one embodiment, the present disclosure is to communicatively connect a new electronic control unit in a vehicle to a 10BASE-T1S Ethernet network, thereby transmitting and receiving data to and from existing electronic control units.

The objectives to be achieved by the present disclosure are not limited to the above-mentioned objectives. Other objectives not mentioned should be more clearly understood by those having ordinary skill in the art from the following description.

According to an embodiment, a method performed by a gateway node in a vehicle is provided. The method includes detecting a first electronic control unit in the vehicle and determining whether to perform pairing with the first electronic control unit using first information received from the first electronic control unit. The first electronic control unit is a unit added to an in-vehicle network and the first information includes information about an electronic control unit requested by the first electronic control unit and information about a message requested by the first electronic control unit. The method also includes performing pairing with the first electronic control unit based on determining that the electronic control unit requested by the first electronic control unit and the message requested by the first electronic control unit are present in a communication channel. The method additionally includes transmitting Physical Layer Collision Avoidance (PLCA) registration request information to a master node based on the pairing. The method also includes transmitting a beacon received from the master node to the first electronic control unit based on determining that information about a node identifier (ID) of the first electronic control unit and information about Transmission Opportunity (TO) of the first electronic control unit are set by the master node using the PLCA registration request information.

According to another embodiment, a gateway node is provided. The gateway node includes a memory and at least one processor. The least one processor is configured to detect a first electronic control unit in the vehicle and determine whether to perform pairing with the first electronic control unit using first information received from the first electronic control unit. The first electronic control unit is a unit added to an in-vehicle network and the first information includes information about an electronic control unit requested by the first electronic control unit and information about a message requested by the first electronic control unit. The at least one processor is also configured to perform pairing with the first electronic control unit based on determining that the electronic control unit requested by the first electronic control unit and the message requested by the first electronic control unit are present in a communication channel. The at least one processor is additionally configured to transmit PLCA registration request information to a master node based on the pairing. The at least one processor is also configured to transmit a beacon received from the master node to the first electronic control unit, based on determining that information about a node ID of the first electronic control unit and information about TO of the first electronic control unit are set by the master node using the PLCA registration request information.

According to yet another embodiment, a computer-readable recording medium storing computer-executable instructions is provided. The computer-executable instructions, when executed by at least one processor, cause the at least one processor to detect a first electronic control unit in the vehicle and determine whether to perform pairing with the first electronic control unit using first information received from the first electronic control unit. The first electronic control unit is a unit added to the vehicle and the first information includes information about an electronic control unit requested by the first electronic control unit and information about a message requested by the first electronic control unit. The computer-executable instructions, when executed by the at least one processor, also cause the at least one processor to perform pairing with the first electronic control unit based on determining that the electronic control unit requested by the first electronic control unit and the message requested by the first electronic control unit are present in a communication channel. The instructions, when executed by the at-least one processor, additionally cause the at least one processor to transmit PLCA registration request information to a master node based on the pairing and transmit a beacon received from the master node to the first electronic control unit based on determining that information about a node ID of the first electronic control unit and information about TO of the first electronic control unit are set by the master node using the PLCA registration request information.

According to embodiments of the present disclosure, there is an effect that can communicatively connect a new electronic control unit in a vehicle to a 10BASE-T1S Ethernet network without the necessity of changing the configuration of a separate communication wire.

According to embodiments of the present disclosure, there is an effect that allows a new electronic control unit in a vehicle to implement a function.

According to embodiments of the present disclosure, there is an effect that can expand a function based on a Software Defined Vehicle (SDV).

Effects of the present disclosure are not limited to the above-mentioned effects. Other effects that are not mentioned herein should be more clearly understood by those having ordinary skill in the art from the following description.

### BRIEF DESCRIPTION OF THE DRAWINGS

FIG. 1 is a diagram for explaining a process in which a new electronic control unit in a vehicle is paired with a gateway node, according to one embodiment of the present disclosure.

FIG. 2 is a block diagram for explaining a gateway node, according to one embodiment of the present disclosure.

FIG. 3 is a block diagram for explaining a master node, according to one embodiment of the present disclosure.

FIG. 4 is a diagram for explaining a process in which a new electronic control unit in a vehicle is communicatively connected to a 10BASE-T1S Ethernet network to transmit and receive data, according to one embodiment of the present disclosure.

FIG. 5 is a flowchart for explaining a process in which a new electronic control unit in a vehicle is communicatively connected to a 10BASE-T1S Ethernet network to transmit and receive data, according to one embodiment of the present disclosure.

FIG. 6 is a flowchart for explaining a process in which a gateway node communicatively connects a new electronic control unit in a vehicle to a 10BASE-T1S Ethernet network, according to one embodiment of the present disclosure.

FIG. 7 is a flowchart for explaining a process in which a master node communicatively connects a new electronic control unit in a vehicle to a 10BASE-T1S Ethernet network, according to one embodiment of the present disclosure.

The drawings described herein are for illustration purposes only and are not intended to limit the scope of the present disclosure in any way.

### DETAILED DESCRIPTION

Hereinafter, embodiments of the present disclosure are described in detail with reference to the accompanying drawings. In the accompanying drawings, like reference numerals designate like elements even when the elements are shown in different drawings. Further, in the following description, a detailed description of known functions and configurations incorporated therein has been omitted for the purpose of clarity and for brevity.

Additionally, various terms such as first, second, A, B, (a), (b), and the like, are used solely to differentiate one component from another but not to imply or suggest the substance, order, or sequence of the components. Throughout this specification, when a part ‘has’, ‘includes’, or ‘comprises’ a component, the part is meant to further include other components, not to exclude other components unless specifically stated to the contrary. The terms such as ‘unit’, ‘module’, and the like refer to one or more units for processing at least one function or operation, which may be implemented by hardware, software, or a combination thereof. When a component, unit, module, controller, device, element, apparatus, or the like of the present disclosure is described as having a purpose or performing an operation, function, or the like, the component, unit, module, controller, device, element, apparatus, or the like should be considered herein as being “configured to” meet that purpose or to perform that operation or function. Each component, unit, module, controller, device, element, apparatus, and the like may separately embody or be included with a processor and a memory, such as a non-transitory computer readable media, as part of the apparatus.

The following detailed description, together with the accompanying drawings, is intended to describe embodiments of the present disclosure, and is not intended to represent the only embodiments by which the present disclosure may be practiced.

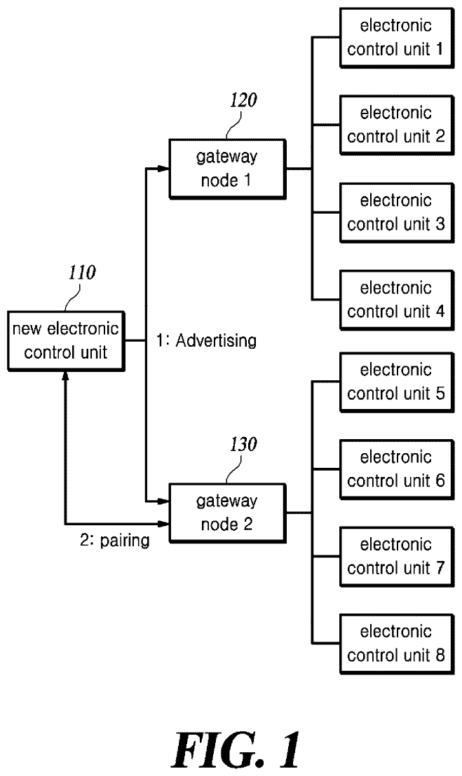

FIG. 1 is a diagram for explaining a process in which a new electronic control unit in a vehicle is paired with a gateway node, according to one embodiment of the present disclosure.

Referring to FIG. 1, when a new electronic control unit 110 is installed in a vehicle and the power of the vehicle is supplied thereto, the new electronic control unit 110 may perform an Advertising operation and may transmit Advertising information to a first gateway node 120 and a second gateway node 130. The Advertising operation may be an operation in which an electronic control unit based on a Bluetooth Low Energy (BLE) network transmits information of the electronic control unit to a neighboring BLE network-based gateway node. The BLE is a low-power communication using Bluetooth. The Advertising information may include information about an electronic control unit requested by the new electronic control unit 110 and a message to be received.

The first gateway node 120 and the second gateway node 130 may detect the new electronic control unit 110. The first gateway node 120 and the second gateway node 130 may use an internal electronic control unit list and a message list to check whether the electronic control unit requested by the new electronic control unit 110 and the message to be received are in a communication channel. The first gateway node 120 may be connected to a first electronic control unit, a second electronic control unit, a third electronic control unit, and a fourth electronic control unit using an Ethernet network. The second gateway node 130 may be connected to a fifth electronic control unit, a sixth electronic control unit, a seventh electronic control unit, and an eighth electronic control unit using the Ethernet network.

When the electronic control unit requested by the new electronic control unit 110 is the fifth electronic control unit, the first gateway node 120 may determine that the fifth electronic control unit is not on the communication channel and is not paired with the new electronic control unit 110. When a cooperative control unit requested by the new electronic control unit 110 is the fifth electronic control unit, the second gateway node 130 may determine that the fifth electronic control unit is on the communication channel and is paired with the new electronic control unit 110. Thus, the new electronic control unit 110 is connected to the second gateway node 130.

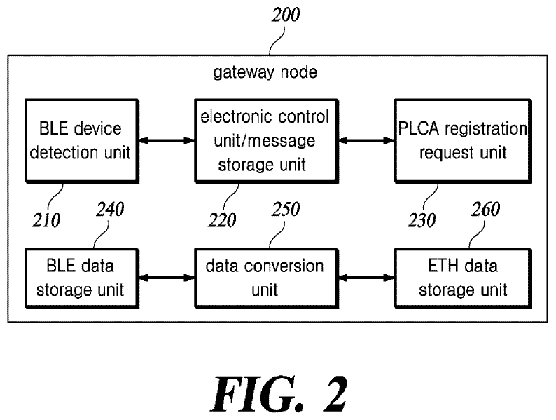

FIG. 2 is a block diagram for explaining a gateway node, according to one embodiment of the present disclosure.

Referring to FIG. 2, a gateway node 200 includes all or some of a BLE device detection unit 210, an electronic control unit/message storage unit 220, a PLCA registration request unit 230, a BLE data storage unit 240, a data conversion unit 250, and an Ethernet (ETH) data storage unit 260. The gateway node 200 and each component thereof may be implemented as hardware or software, or as a combination of hardware and software. In addition, the function of each component may be implemented in software, and one or more processors may be implemented to execute the function of the software corresponding to each component.

The BLE device detection unit 210 may detect an electronic control unit that performs communication based on a BLE network in the vehicle. The BLE device detection unit 210 may detect the new electronic control unit 110 in the vehicle using communication based on the BLE network. The electronic control unit/message storage unit 220 may store a list of electronic control units and messages present in the communication channel. The electronic control unit/message storage unit 220 may compare the Advertising information transmitted by the new electronic control unit 110 in the vehicle with the list of the electronic control units and messages to check whether the electronic control unit and message requested by the new electronic control unit 110 are present in the communication channel. The electronic control unit/message storage unit 220 may transmit feedback information to the BLE device detection unit 210. The feedback information may be information indicating whether the new electronic control unit 110 needs to be connected to the in-vehicle network.

When the electronic control unit and message requested by the new electronic control unit 110 are present in the communication channel, the electronic control unit/message storage unit 220 may transmit feedback information indicating that the new electronic control unit 110 needs to be connected to the in-vehicle network to the BLE device detection unit 210. When the electronic control unit and message requested by the new electronic control unit 110 are not present in the communication channel, the electronic control unit/message storage unit 220 may transmit feedback information indicating that the new electronic control unit 110 does not need to be connected to the in-vehicle network to the BLE device detection unit 210.

When the new electronic control unit 110 needs to be connected to the in-vehicle network, the BLE device detection unit 210 may request PLCA registration to the PLCA registration request unit 230 to allow the new electronic control unit 110 to transmit and receive data. The PLCA registration request unit 230 may transmit the PLCA registration request information to a master node. The PLCA registration request information may be information that requests the new electronic control unit 110 to be registered in the PLCA and connected to the Ethernet network. The BLE data storage unit 240 may store data transmitted by the new electronic control unit 110 using BLE network-based communication. The BLE data storage unit 240 may transmit data transmitted by the new electronic control unit 110 to the data conversion unit 250. The BLE data storage unit 240 may store BLE packet-type data that the new electronic control unit 110 needs to receive. The BLE data storage unit 240 may transmit the BLE packet-type data to the new electronic control unit 110 using the BLE network-based communication.

The data conversion unit 250 may convert the BLE packet-type data transmitted by the new electronic control unit 110 into ETH packet-type data and may transmit the ETH packet-type data to the ETH data storage unit 260. The data conversion unit 250 may convert the ETH packet-type data that the new electronic control unit 110 needs to receive into the BLE packet-type data and may transmit the BLE packet-type data to the BLE data storage unit 240. The ETH data storage unit 260 may transmit the ETH packet-type data to another electronic control unit using the Ethernet network. The ETH data storage unit 260 may receive the ETH packet-type data that the new electronic control unit 110 needs to receive from another electronic control unit using the Ethernet network. The ETH data storage unit 260 may transmit the ETH packet-type data that the new electronic control unit 110 needs to receive to the data conversion unit 250.

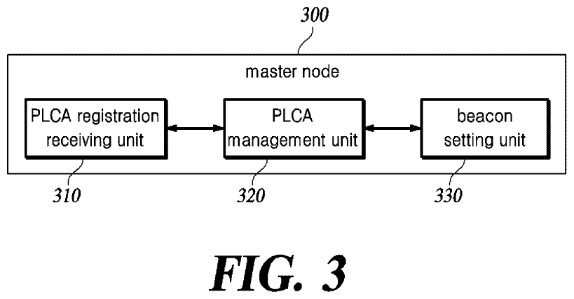

FIG. 3 is a block diagram for explaining a master node, according to one embodiment of the present disclosure.

Referring to FIG. 3, a master node 300 includes all or some of a PLCA registration receiving unit 310, a PLCA management unit 320, and a beacon setting unit 330. The master node 300 and each component thereof may be implemented as hardware or software, or as a combination of hardware and software. In addition, the function of each component may be implemented in software, and one or more processors may be implemented to execute the function of the software corresponding to each component.

The PLCA registration receiving unit 310 may receive PLCA registration request information from the gateway node 200 and may transmit the PLCA registration request information to the PLCA management unit 320. The PLCA management unit 320 may statically manage information about a node identifier (ID) and Transmission Opportunity (TO) assigned to each electronic control unit. The PLCA management unit 320 may manage information about the node ID and TO assigned to each electronic control unit using a PLCA management table. The PLCA management table may be a table that indicates the node ID assigned to each electronic control unit and an order in which data is transmitted for each electronic control unit. A plurality of node IDs may be assigned to one electronic control unit. The PLCA management unit 320 may set information about the node ID to be assigned to the new electronic control unit 110 and the TO of the new electronic control unit 110. The beacon setting unit 330 may set a beacon using the information about the node ID to be assigned to the new electronic control unit 110 and the TO of the new electronic control unit 110, and may transmit the beacon to the gateway node 200. The gateway node 200 may transmit the beacon to the new electronic control unit 110. The beacon may include the information about the node ID to be assigned to the new electronic control unit 110 and the TO of the new electronic control unit 110.

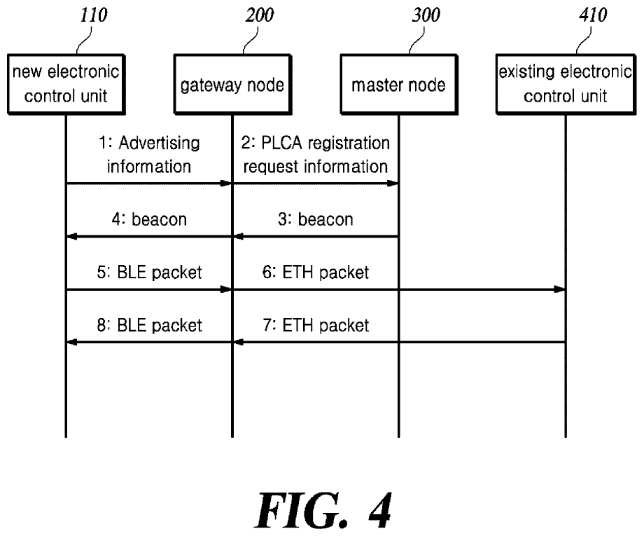

FIG. 4 is a diagram for explaining a process in which a new electronic control unit in a vehicle is communicatively connected to a 10BASE-T1S Ethernet network to transmit and receive data, according to one embodiment of the present disclosure.

Referring to FIG. 4, the new electronic control unit 110 transmits the Advertising information to the gateway node 200. The Advertising information may include information about an electronic control unit and a message requested by the new electronic control unit 110. The gateway node 200 may check whether the electronic control unit and the message requested by the new electronic control unit 110 are present in the communication channel. When the electronic control unit and the message requested by the new electronic control unit 110 are in the communication channel, the gateway node 200 may transmit a PLCA registration request information to the master node 300.

The master node 300 may set the information about the node ID to be assigned to the new electronic control unit 110 and the TO of the new electronic control unit 110. The master node 300 may transmit a beacon including the information about the node ID to be assigned to the new electronic control unit 110 and the TO of the new electronic control unit 110 to the gateway node 200. The gateway node 200 may transmits the beacon to the new electronic control unit 110.

The new electronic control unit 110 may transmit BLE packet-type data to the gateway node 200. The gateway node 200 may convert the BLE packet-type data into the ETH packet-type data and may transmit the ETH packet-type data to an existing electronic control unit 410. The ETH packet-type data may be transmitted based on the Ethernet network. The ETH packet-type data may be transmitted based on the information about the node ID assigned to the new electronic control unit 110 and the TO of the new electronic control unit 110. The existing electronic control unit 410 may be an electronic control unit that is already present in the vehicle, and the new electronic control unit 110 may be an electronic control unit requested using the Advertising information.

The existing electronic control unit 410 may transmit the ETH packet-type data to the gateway node 200. The ETH packet-type data may be information about a message requested by the new electronic control unit 110 using the Advertising information. The gateway node 200 may convert the ETH packet-type data into the BLE packet-type data and may transmit the BLE packet-type data to the new electronic control unit 110. The BLE packet-type data may be transmitted using the BLE network-based communication.

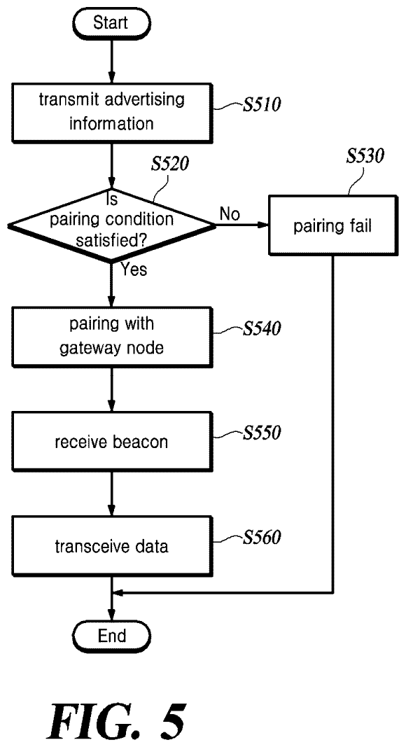

FIG. 5 is a flowchart for explaining a process in which a new electronic control unit in a vehicle is communicatively connected to a 10BASE-T1S Ethernet network to transmit and receive data, according to one embodiment of the present disclosure.

Referring to FIG. 5, the new electronic control unit 110 in the vehicle transmits the Advertising information to the gateway node 200 in a step or operation S510. It is determined whether the pairing condition is satisfied in a step or operation S520. The pairing condition may be whether the electronic control unit and message requested by the new electronic control unit 110 are present in the communication channel. If the pairing condition is not satisfied (No in the step or operation S520), pairing between the gateway node 200 and the new electronic control unit 110 fails at a step or operation S530. If the pairing condition is satisfied (Yes in the step or operation S520), the new electronic control unit 110 performs pairing with the gateway node 200 in a step or operation S540. In a step or operation S550, the new electronic control unit 110 receives the beacon including the information about the node ID for the new electronic control unit 110 set by the master node 300 and the TO of the new electronic control unit 110. In a step or operation S560, the new electronic control unit 110 transmits and receives data using the information about the node ID set by the master node 300 and the TO.

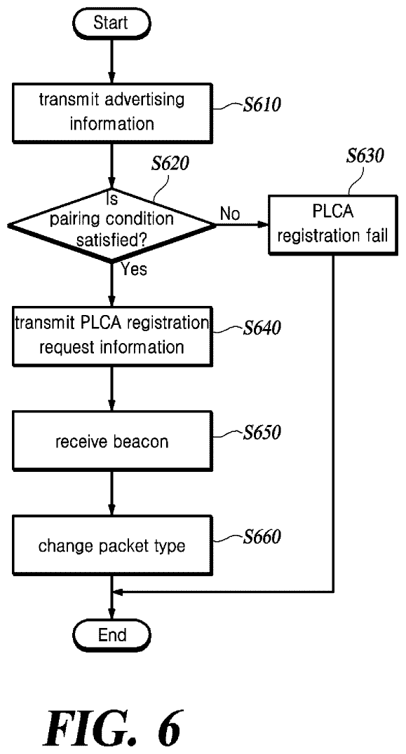

FIG. 6 is a flowchart for explaining a process in which a gateway node communicatively connects a new electronic control unit in a vehicle to a 10BASE-T1S Ethernet network, according to one embodiment of the present disclosure.

Referring to FIG. 6, in a step or operation S610, the gateway node 200 receives the Advertising information from the new electronic control unit 110. In a step or operation S620, it is determined whether a pairing condition is satisfied. The pairing condition may be whether the electronic control unit and message requested by the new electronic control unit 110 are present in the communication channel. If the pairing condition is not satisfied (No in the step or operation S620), the PLCA registration of the new electronic control unit 110 fails in a step or operation S630. If the pairing condition is satisfied (Yes in the step or operation S620), the gateway node 200 transmits the PLCA registration request information to the master node 300 in a step or operation S640. In a step or operation S650, the gateway node 200 receives the beacon including the information about the node ID for the new electronic control unit 110 set by the master node 300 and the TO of the new electronic control unit 110. In a step or operation S660, the gateway node 200 changes the packet form of the data so that the new electronic control unit 110 may transmit and receive data. The gateway node 200 may convert the ETH packet-type data into the BLE packet-type data or convert the BLE packet-type data into the ETH packet-type data.

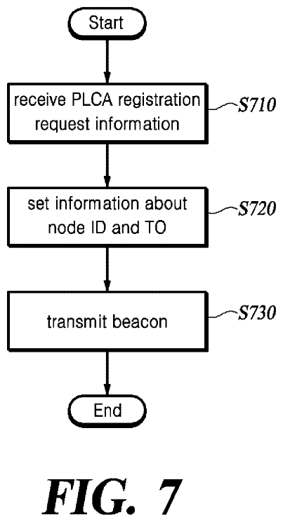

FIG. 7 is a flowchart for explaining a process in which a master node communicatively connects a new electronic control unit in a vehicle to a 10BASE-T1S Ethernet network, according to one embodiment of the present disclosure.

Referring to FIG. 7, in a step or operation S710, the master node 300 receives PLCA registration request information from the gateway node 200. This is a case where the pairing condition is satisfied. In a step or operation S720, the master node 300 sets information about a node ID to be assigned to the new electronic control unit 110 and TO of the new electronic control unit 110. In a step or operation S730, the master node 300 transmits a beacon including the information about the node ID to be assigned to the new electronic control unit 110 and the TO of the new electronic control unit 110 to the gateway node 200. The gateway node 200 transmits the beacon to the new electronic control unit 110.

Each element of the apparatus or method in accordance with embodiments of the present disclosure may be implemented in hardware or software, or a combination of hardware and software. The functions of the respective elements may be implemented in software, and a microprocessor may be implemented to execute the software functions corresponding to the respective elements.

Various embodiments of systems and techniques described herein can be realized with digital electronic circuits, integrated circuits, field programmable gate arrays (FPGAs), application specific integrated circuits (ASICs), computer hardware, firmware, software, and/or combinations thereof. The various embodiments can include implementation with one or more computer programs that are executable on a programmable system. The programmable system includes at least one programmable processor, which may be a special purpose processor or a general purpose processor, coupled to receive and transmit data and instructions from and to a storage system, at least one input device, and at least one output device. Computer programs (also known as programs, software, software applications, or code) include instructions for a programmable processor and are stored in a “computer-readable recording medium.”

The computer-readable recording medium may include all types of storage devices on which computer-readable data can be stored. The computer-readable recording medium may be a non-volatile or non-transitory medium such as a read-only memory (ROM), a compact disc ROM (CD-ROM), magnetic tape, a floppy disk, a memory card, a hard disk, or an optical data storage device. In addition, the computer-readable recording medium may further include a transitory medium such as a data transmission medium. Furthermore, the computer-readable recording medium may be distributed over computer systems connected through a network, and computer-readable program code can be stored and executed in a distributive manner.

Although operations are illustrated in the flowcharts/timing charts in this specification as being sequentially performed, this is merely a description of the technical idea of embodiments of the present disclosure. In other words, those having ordinary skill in the art to which embodiments of the present disclosure belong may appreciate that various modifications and changes can be made without departing from essential features of an embodiment of the present disclosure. In other words, the sequence illustrated in the flowcharts/timing charts can be changed and one or more operations of the operations can be performed in parallel. Thus, flowcharts/timing charts are not limited to the temporal order.

Although embodiments of the present disclosure have been described for illustrative purposes, those having ordinary skill in the art may appreciate that various modifications, additions, and substitutions are possible, without departing from the idea and scope of the present disclosure. Therefore, embodiments of the present disclosure have been described for the sake of brevity and clarity. The scope of the technical idea of the present disclosure is not limited by the illustrations. Accordingly, one of ordinary skill would understand that the scope of the present disclosure is not to be limited by the above explicitly described embodiments but by the claims and equivalents thereof.

What is claimed is:

1. A method performed by a gateway node in a vehicle, the method comprising:
detecting a first electronic control unit in the vehicle;
determining whether to perform pairing with the first electronic control unit using first information received from the first electronic control unit, the first information including information about an electronic control unit requested by the first electronic control unit and information about a message requested by the first electronic control unit;
performing pairing with the first electronic control unit based on determining that the electronic control unit requested by the first electronic control unit and the message requested by the first electronic control unit are present in a communication channel;
transmitting Physical Layer Collision Avoidance (PLCA) registration request information to a master node based on the pairing; and
transmitting a beacon received from the master node to the first electronic control unit based on determining that information about a node identifier (ID) of the first electronic control unit and information about Transmission Opportunity (TO) of the first electronic control unit are set by the master node using the PLCA registration request information,
wherein the first electronic control unit is a unit added to an in-vehicle network.

2. The method of claim 1, wherein the beacon includes the information about the node ID of the first electronic control unit and the information about the TO of the first electronic control unit.

3. The method of claim 1, further comprising changing packet form of data to enable the first electronic control unit to transmit and receive data.

4. The method of claim 3, wherein changing the packet form of data includes:
converting Bluetooth Low Energy (BLE) packet-type data received from the first electronic control unit into Ethernet (ETH) packet-type data; and
transmitting the ETH packet-type data to a second electronic control unit.

5. The method of claim 4, wherein changing the packet form of data further includes:
converting the ETH packet-type data received from the second electronic control unit into BLE packet-type data; and
transmitting the BLE packet-type data to the first electronic control unit.

6. The method of claim 5, wherein the ETH packet-type data received from the second electronic control unit includes data determined based on the information about the message requested by the first electronic control unit.

7. The method of claim 5, wherein the second electronic control unit is a unit determined based on the electronic control unit requested by the first electronic control unit.

8. A gateway node comprising:
a memory; and
at least one processor,
wherein the at least one processor is configured to:
detect a first electronic control unit in a vehicle;
determine whether to perform pairing with the first electronic control unit using first information received from the first electronic control unit, the first information comprising information about an electronic control unit requested by the first electronic control unit and information about a message requested by the first electronic control unit;
perform pairing with the first electronic control unit based on determining that the electronic control unit requested by the first electronic control unit and the message requested by the first electronic control unit are present in a communication channel;
transmit Physical Layer Collision Avoidance (PLCA) registration request information to a master node based on the pairing; and
transmit a beacon received from the master node to the first electronic control unit based on determining that the master node sets information about a node identifier (ID) of the first electronic control unit and information about Transmission Opportunity (TO) of the first electronic control unit using the PLCA registration request information,
wherein the first electronic control unit is a unit added to an in-vehicle network.

9. The gateway node of claim 8, wherein the beacon includes the information about the node ID of the first electronic control unit and the information about the TO of the first electronic control unit.

10. The gateway node of claim 8, wherein the at least one processor is further configured to change packet form of data to enable the first electronic control unit to transmit and receive data.

11. The gateway node of claim 10, wherein the at least one processor is configured to:
convert Bluetooth Low Energy (BLE) packet-type data received from the first electronic control unit into Ethernet (ETH) packet-type data; and
transmit the ETH packet-type data to a second electronic control unit.

12. The gateway node of claim 11, wherein the at least one processor is further configured to:
convert the ETH packet-type data received from the second electronic control unit into BLE packet-type data; and
transmit the BLE packet-type data to the first electronic control unit.

13. The gateway node of claim 12, wherein the ETH packet-type data received from the second electronic control unit includes data determined based on the information about the message requested by the first electronic control unit.

14. The gateway node of claim 12, wherein the second electronic control unit is a unit determined based on the electronic control unit requested by the first electronic control unit.

15. A non-transitory computer-readable recording medium storing computer-executable instructions that, when executed by at least one processor, cause the at least one processor to:
detect a first electronic control unit in a vehicle;
determine whether to perform pairing with the first electronic control unit using first information received from the first electronic control unit, the first information including information about an electronic control unit requested by the first electronic control unit and information about a message requested by the first electronic control unit;
perform pairing with the first electronic control unit based on determining that the electronic control unit requested by the first electronic control unit and the message requested by the first electronic control unit are present in a communication channel;
transmit Physical Layer Collision Avoidance (PLCA) registration request information to a master node based on the pairing; and
transmit a beacon received from the master node to the first electronic control unit based on determining that information about a node identifier (ID) of the first electronic control unit and information about Transmission Opportunity (TO) of the first electronic control unit using the PLCA registration request information are set by the master node,
wherein the first electronic control unit is a unit added to the vehicle.
